(19) United States
(12) Patent Application Publication
(10) Pub. No.: US 2019/0392345 A1
(43) Pub. Date: Dec. 26, 2019

(54) AUTOMATIC ACTION LOADING BASED ON A DATA CONTEXT AND A MACHINE-LEARNED MODEL

(71) Applicant: Holland & Hart LLP, Salt Lake City, UT (US)

(72) Inventors: Jason William Adaska, Westminster, CO (US); Gareth Bruce Middleton, Fort Collins, CO (US); James Culbertson Clow, Boulder, CO (US); Joseph Aubrey Keuhlen, Boulder, CO (US)

(21) Appl. No.: 16/452,066

(22) Filed: Jun. 25, 2019

Related U.S. Application Data
(60) Provisional application No. 62/690,338, filed on Jun. 26, 2018.

(51) Int. Cl. G06N 20/00; G06N 5/04

(52) U.S. Cl. CPC G06N 20/00; G06N 5/04

(57) ABSTRACT

Methods, systems, and devices for automated application and/or action loading are described. A system may perform a machine learning process on historical or real-time information correlating a data context for a first application with one or more actions to perform in a second application. Based on the machine learning process, the system may determine a machine-learned function. A user device may input a current data context for the first application into the machine-learned function and may receive a suggestion as an output. This suggestion may be an action, an ensemble of actions, a second application, etc. The user device may present (e.g., display) an indication of one or more suggestions determined by the machine-learned function in a user interface, where a user may select to execute a suggestion (e.g., an action, a function in an application, etc.). In some cases, the machine-learned models are user-specific, application-specific, or both.

### CROSS REFERENCE

The present Application for Patent claims the benefit of U.S. Provisional Patent Application No. 62/690,338 by Adaska et al., entitled “AUTOMATIC APPLICATION LOADING BASED ON A DATA CONTEXT AND A MACHINE-LEARNED MODEL,” filed Jun. 26, 2018, assigned to the assignee hereof, and expressly incorporated herein.

### FIELD OF TECHNOLOGY

The present disclosure relates generally to data processing and machine learning techniques, and more specifically to automatically selecting and loading actions for applications using a machine-learned model.

### BACKGROUND

In many systems, users may run multiple different applications on a user device. These applications may correspond to a wide range of application types, as well as supported functionality for the different applications. However, certain tasks may be correlated across applications. For example, if a certain task or trigger occurs in a first application, a user may often perform a task in a second application. The user may have to identify this second application to launch, navigate away from the first application to the chosen application, launch it, and interact with it in a different interface. The time and effort involved on the part of the user to switch and manually launch applications constitutes a significant amount of their daily work effort. Additionally, this may introduce processing latency into the system, as the system begins preparing the second application or tasks in the second application only after the user manually selects to launch the second application.

### BRIEF DESCRIPTION OF THE DRAWINGS

FIG. 1 illustrates an example of a system that supports automatic action loading based on a data context and a machine-learned model in accordance with aspects of the present disclosure.

FIG. 2 illustrates an example of a user interface that supports automatic action loading based on a data context and a machine-learned model in accordance with aspects of the present disclosure.

FIG. 3 illustrates an example of a system that supports automatic action loading based on a data context and a machine-learned model in accordance with aspects of the present disclosure.

FIGS. 4A and 4B illustrate examples of machine-learned models that support automatic action loading based on a data context and a machine-learned model in accordance with aspects of the present disclosure.

FIG. 5 shows a block diagram of an apparatus that supports automatic action loading based on a data context and a machine-learned model in accordance with aspects of the present disclosure.

FIG. 6 shows a block diagram of an application determination module that supports automatic action loading based on a data context and a machine-learned model in accordance with aspects of the present disclosure.

FIG. 7 shows a diagram of a system including a device that supports automatic action loading based on a data context and a machine-learned model in accordance with aspects of the present disclosure.

FIG. 8 shows a block diagram of an apparatus that supports automatic action loading based on a data context and a machine-learned model in accordance with aspects of the present disclosure.

FIG. 9 shows a block diagram of an application determination module that supports automatic action loading based on a data context and a machine-learned model in accordance with aspects of the present disclosure.

FIG. 10 shows a diagram of a system including a device that supports automatic action loading based on a data context and a machine-learned model in accordance with aspects of the present disclosure.

FIGS. 11 through 14 show flowcharts illustrating methods that support automatic action loading based on a data context and a machine-learned model in accordance with aspects of the present disclosure.

### DETAILED DESCRIPTION

An action suggestion tool may be employed by a user or a system to streamline the workflow within an application, which may be referred to as a productivity environment (e.g., Microsoft® Outlook). Users may employ the action suggestion tool to reduce the time taken to accomplish tasks, by avoiding the need to manually select or open external applications. This may reduce the processing latency within the system associated with executing these tasks. The action suggestion tool may further populate key activities exposed by the application automatically based on the given context. The action suggestion tool may exist as an add-on or plugin for existing productivity environments or may exist as a stand-alone piece of software.

In one example, the action suggestion tool is embodied by an add-in to an email client. The email client passes contextual information to the tool, which then suggests additional applications the user may wish to launch, e.g., a time entry interface, a document-filing interface, a note-taking interface, or a combination of these or some similar interface or application. In some cases, the suggestions may include actions to perform in one or more of these additional applications (e.g., a suggested time entry for submission in a time entry application). In some examples, the contextual information may include information related to an email body, email headers (e.g., to, from, carbon copy (cc), subject, etc.), attached documents, or some combination of these. This data context for an application may be based on a single value, a set of values, or some combination of multiple values (e.g., a specific sequence of values, a specific combination of values, etc.).

The action suggestion tool may determine an action or application to suggest based on a machine-learned model (i.e., a machine-learned function). This model may be trained using historical and/or “real-time” data from a first application (e.g., an email application). A device supporting backend processing (e.g., a server, such as a web server, a cloud server, a server cluster, etc.) may perform the model training to tune weights within the machine-learned model. When released, the trained model may accept one or more data context vectors as input and may output one or more output probability vectors. An output probability vector may include a set of probability values each indicating a probability that a respective action should be suggested by the action suggestion tool. One or more suggested actions may be presented in a plugin (e.g., a side panel) to the email application based on the output probability vector. If a user selects to perform one of the suggested actions, the plugin may handle performing the action in a second application (e.g., an application different than the email application, such as a time entry application, a word processing application, etc.) without navigating the user away from the first application. The backend processing device may additionally reinforce the model training based on the user selection.

Aspects of the disclosure are initially described in the context of a system supporting machine-learning processes and automated application and/or task loading. Aspects of the disclosure are further illustrated by and described with reference to apparatus user interfaces, machine-learned models, diagrams, system diagrams, and flowcharts that relate to automatic action loading based on a data context and a machine-learned model.

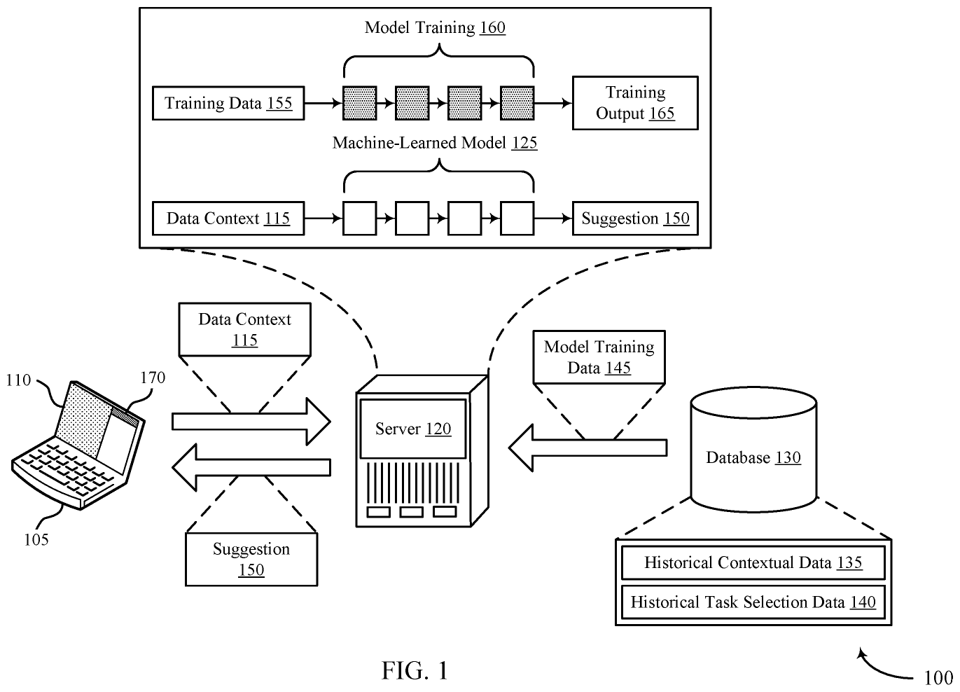

FIG. 1 illustrates an example of a system 100 that supports automatic action loading based on a data context and a machine-learned model in accordance with aspects of the present disclosure. The system 100 may include a user device 105 (e.g., a laptop, a desktop computer, a mobile device, a smart device, an internet-of-things (IoT) device, etc.), a server 120 (e.g., a database server, an application server, a web server, a cloud server, a server cluster, a virtual machine, a physical server, a machine learning server, etc.), a database 130 (e.g., a database, a database system, a data store, a data lake, a cloud-based storage system, etc.), or some combination of these and/or other devices. These devices may interact within the system to perform a machine learning procedure, and may implement a process (e.g., a function, algorithm, model, etc.) determined using the machine learning procedure to improve application and/or task loading at the user device 105. As such, the machine learning procedure may involve two parts: training by a training apparatus (i.e., model training 160) and prediction using a machine-learned model 125. Specifically, based on a data context 115 for a user or user device 105, the system 100 may produce a suggestion 150 as to a next task or ensemble of tasks for the user or user device 105 to execute. In some cases, this system 100 may be referred to as an action suggestion system or an application suggestion system.

A central element of the suggestion framework is the machine-learned model 125. In a first example, the machine-learned model 125 may be a linear support vector machine (LSVM). Such a machine-learned model 125 may support identifying a next action to perform in a second application based on a data context 115 in a first application (or in multiple first applications). In a second example, the machine-learned model 125 may be a sequence-to-sequence (seq2seq) model. Seq2seq models may be effective in the domain of machine translation, in which a sequence of terms in one language must be mapped to a sequence of words in another. In one case, the input “language” is a data context 115, while the output language is a suggestion 150 representing a suggested sequence of tasks or applications for the user or user device 105 to execute next. In another example, the machine-learned model 125 may be a sequence-to-tree elaboration, which may capture a complicated orchestration of tasks for the suggestion 150. Other examples of machine-learned models 125 include recurrent neural networks (RNNs), convolutional neural networks (CNNs), long short-term memory (LSTM) models, or any other types of machine-learned models 125 supporting automated action selection. In some examples, the machine-learned model 125 may be implemented using the Tensorflow™ programming library and may be executed on a graphics processing unit (GPU).

To train the machine-learned model 125 (e.g., during a machine learning procedure), extensive contextual and task-selection data may be gathered for one or more users, which may be stored in a database 130. For example, the database 130 may store historical contextual data 135 and corresponding historical task selection data 140, including sequences of actions performed. In some cases, the data may be stored and/or labeled automatically as a user interacts with an application (e.g., a client application 110) at a user device 105. Additionally or alternatively, the data may be associated with a specific user, a specific group or type of users, an organization, or some combination of these in the database 130. The historical contextual data 135 and historical task selection data 140 may be used as model training data 145 in model training 160. In some cases, training data 155 for model training 160 may additionally or alternatively include real-time or pseudo-real-time data from a user device 105. The model training 160 may identify patterns or associations between specific data contexts 115 or specific aspects of data contexts 115 and selected tasks. The model training 160 may utilize this information to determine a machine-learned model 125 that can receive one or more data contexts 115 as input, and may output one or more suggestions 150 (e.g., task or application suggestions) based on the input and trained model. The model may be trained at server 120, or at database 130 or user device 105. For example, the model training 160 may occur on the backend by a computing device supporting a machine-learning accelerated environment with one or more GPUs and/or central processing units (CPUs), such as a machine-learning server, a cloud server supporting a cloud-based environment, an application server, a server cluster, a virtual machine, a database server, or any combination of these or other machine-learning environments. In some cases, the model may be trained based on a bounded set of model training data 145 retrieved from the database 130. In other cases, the model may be continuously trained based on incoming data contexts 115 and task selections or based on periodic or aperiodic batches of model training data 145 retrieved from database 130.

In an example, model training 160 may involve passing training data 155 through a training model to calculate training output 165 based on a current set of weights in the training model. For example, the training data 155 may be an example of an input vector (or a sequence of input vectors), and the values of the input vector may be assigned to a set of input nodes in an input node layer of the training model. These input node values may pass through a number of hidden layers of the training model, where the values are modified based on weights between the nodes of the training model. Following the hidden layer(s), the training model may calculate output node values in an output layer, where each output node corresponds to a particular suggested action to perform. The set of output nodes may correspond to an output vector (e.g., the training output 165), where the values of the output nodes are probabilities each corresponding to a specific probability that a respective action should be suggested by the action suggestion system. The model training 160 may compare the training output 165 to actual action selection data (e.g., historical task selection data 140 or on-the-fly action selection data from the user device 105) and may update the weights of the training model based on the comparison. For example, if the action corresponding to the highest probability value in the training output 165 is selected by the user, the current training model may be reinforced based on the feedback. However, if an action other than the action corresponding to the highest probability value in the training output 165 is selected by the user, the weights in the training model may be adjusted such that the probability of the actually selected action increases for a same data context 115.

Following initial training, the training model (e.g., the machine-learned model 125) may be released for on-line use by users. In some cases, the machine-learned model 125 may continue to run on the backend (e.g., in a cloud-based environment, on a backend server, etc.). In other cases, the user device 105 may download the machine-learned model 125 and may perform the action suggestion locally on the user device 105. In some implementations, the model training 160 may continue following release of the machine-learned model 125. This model training 160 may run in the background in real-time or pseudo-real-time, or the model training 160 may run according to a machine-learning schedule (e.g., data contexts 115 and actions may be stored throughout the day, and model training may run each day at midnight on the stored information). This continued model training 160 may be based on feedback by a user operating the user device 105. For example, if an action is suggested by the machine-learned model 125, and the user selects to perform the suggested action, this selection may be fed back to the server 120 for model training 160 to reinforce the model. An updated machine-learned model 125 may be released (e.g., implemented in the cloud or pushed to the user device 105) based on a trigger, such as a performance-based trigger, a periodic trigger, and/or a user trigger. For example, if the performance of the updated model (e.g., the accuracy of the updated model's suggestions) is a threshold amount greater than the performance of the current model, the updated model may be released. Additionally or alternatively, an updated model may be released periodically (e.g., based on a released schedule) or based on a user selection (e.g., an administrative user may select to release an updated model).

To produce a suggestion 150, the user's data context 115 for a client application 110 may be sent from the user device 105 for processing by the machine-learned model 125 (e.g., at the server 120 or at the user device 105). A data context 115 may be an example of parameters associated with the application 110. For example, if the application 110 is an email application, the data context 115 may correspond to aspects of an email (e.g., recipient(s), sender(s), subject line, words or phrases in the body of the email, a timestamp associated with sending or receiving the email, etc.) displayed in the user interface of the user device 105. In a second example, if the application 110 is a calendar application, the data context 115 may correspond to aspects of a calendar event (e.g., participant(s), a time associated with the event, etc.) displayed in the user interface or multiple calendar events displayed as a calendar view in the user interface. It should be understood that many other data contexts 115 across many types of applications 110 may be used for determining suggestions 150 using one or more of the techniques described herein. For example, applications 110 and/or data contexts 115 presented in other manners (e.g., information presented auditorily, tactilely, etc. in non-visual or hybrid-sensory presentations) may be used for automatic action loading as described herein.

The server 120 or user device 105 may run the machine-learned model 125 to produce suggestion 150. The suggestion 150 may be an example of a task for a user or user device 105 to perform. In some cases, this suggestion 150 is associated with a second application. For example, a plugin 170 to the client application 110 may present (e.g., as a visual display, as audio, as tactile information, or as any combination of these) a portion of the second application if the second application is a time entry application, where the suggestion 150 may correspond to creating a time entry in the second application based on the data context 115 of the application 110. In a second example, the second application may be a calendar application, the suggestion 150 may be a suggested meeting (e.g., including one or more suggested times, locations, members, etc. for the meeting) to create a calendar event in the second application based on an email sent or received in the application 110. The suggestion 150 may be obtained by the user device 105 for presentation (e.g., from the server 120 or from the plugin 170 at the user device 105). For example, the user device 105 may display a set of suggested applications or tasks in the user interface (e.g., within the plugin 170 for the first application 110). In some cases, a user may select an application or action to execute the suggestion 150. In other cases, the user device 105 may automatically execute an application or action based on the suggestion 150. For example, if the machine-learned model 125 or some other analysis system determines a confidence level for the suggestion 150 that is greater than some confidence threshold, the user device 105 may automatically execute the application or action based on the suggestion 150. In some examples, a user may grant permission for the user device 105 to automatically perform one or more actions suggested by the machine-learned model 125. This automatic processing (e.g., execution) of a suggested action may be performed based on a configuration of the machine-learned model 125.

In some cases, the system 100 may determine separate machine-learned models 125 for different applications 110, different users, different groups of users, different organizations, different user devices 105, or some combination of these. For example, a given data context 115 in an application 110 for one user operating a user device 105 may result in a different suggestion 150 than the same data context 115 in the same application 110 for a different user operating a user device 105.

In conventional systems, with many applications to choose from at a user device, selecting the correct application to present to a user is a significant technical problem. Conventional systems depend on user intervention; i.e., the user identifies the application to launch, navigates away from a currently running application (e.g., their productivity tool) to the chosen application, launches this chosen application, and interacts with the chosen application in a different interface. The time and effort involved on the part of the user to switch and manually launch applications constitutes a significant amount of their daily work effort. Additionally, if the system waits for the user to launch the chosen application, the system experiences a significant amount of processing latency associated with performing tasks within the chosen application. Furthermore, in some cases, tasks performed in this chosen application may be based on data stored in a database. Retrieving this data may be associated with a non-trivial latency value. Waiting for a user to input the data to retrieve for the chosen application may be inefficient from a processing standpoint.

In contrast, the system 100 may implement a machine-learned model 125 that can determine (e.g., specifically for each user, user device 105, group of users, group of user devices 105, etc.) a correct application and/or action to suggest. The machine-learned model 125 may be trained using a history of each user's actions and may suggest an action to perform based upon the specific data context 115 in an application 110 the user is interacting with at the time the suggestion 150 is requested. Additionally, the suggestion 150 may be introduced as an option to execute within the current productivity tool, removing the need for the user to switch applications 110, and reducing the processing latency associated with performing the suggested task or launching the suggested application. Additionally, the machine-learned model 125 may populate one or more fields for the suggested task or application based on the data context 115. This may involve querying one or more data records from the database 130 or retrieving the data records from the application 110, where these data records may be displayed in the plugin 170. In either case, automating this step using the machine-learned model 125 to retrieve data likely to be utilized by the user in the suggested action or application may further reduce the processing latency, improving the efficiency of the system 100.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

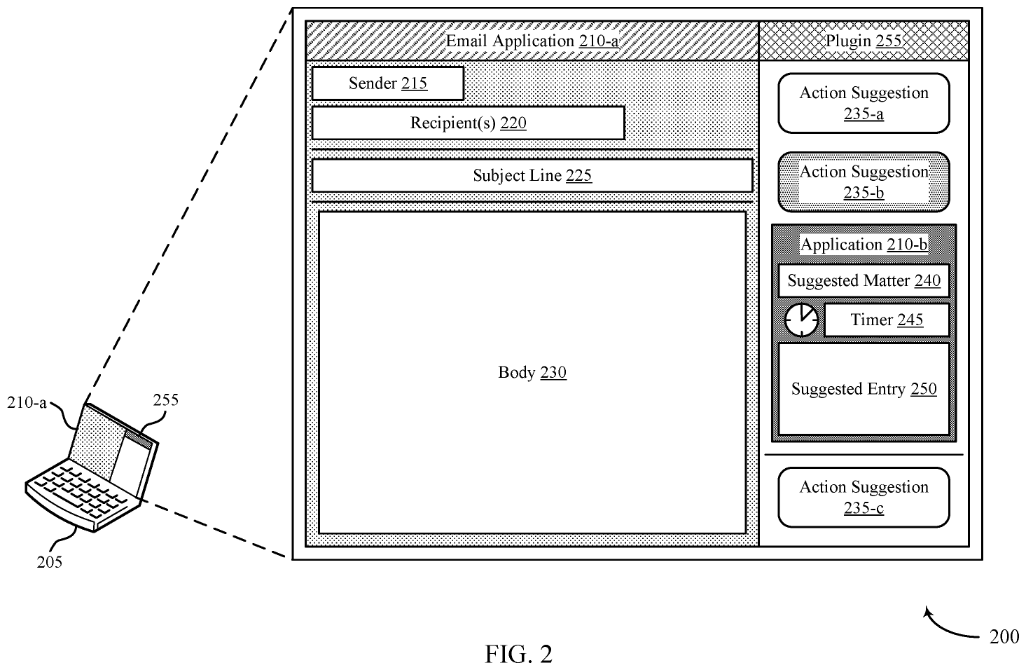

FIG. 2 illustrates an example of a user interface 200 that supports automatic action loading based on a data context and a machine-learned model in accordance with aspects of the present disclosure. The user interface 200 may be an example of a user interface for a user device 205 and may include two fields. A first field may correspond to a first application 210a, while a second field may be an example of an add-on or plugin 255 for the first application 210-a. As illustrated, the first application 210-a may be an example of an email application 210-a and may be the main application displayed at the user device 205. The plugin 255 may be an example of a sidebar or side pane presenting suggested actions, suggested applications, or a combination thereof, where the plugin 255 is a plugin for the email application 210-a. These two fields may be presented in other configurations, and other applications may be supported for automating action and/or application suggestion.

The user interface 200 may include a data context 115, as described with reference to FIG. 1. For example, the data context 115 may correspond to the email application 210-a displayed in the user interface 200. The context may include or be based on the sender 215, the recipient(s) 220, the subject line 225, the body 230, or some combination of these. For example, the user device 205 or a server (e.g., server 120 described with reference to FIG. 1) may perform a natural language processing (NLP) procedure on the subject line 225, the body 230, or both of an email displayed in the email application 210-a in order to determine one or characteristics or triggers for the data context 115. A machine-learned model may produce one or more action suggestions 235 (e.g., action suggestions 235-a, 235-b, and 235-c) based on the data context. In some cases, these action suggestions 235 may correspond to other applications 210. The suggestions may be displayed alongside the email application 210-a (e.g., in a pane, such as the plugin 255) in the user interface 200. In this way, a user may not need to navigate away from the email application 210-a to perform action suggestions 235, even if an action suggestion 235 corresponds to an operation or function executed within a separate application 210-b.

As illustrated, action suggestion 235-b may correspond to application 210-b (e.g., a second application 210 different from the first application 210-a displayed in the user interface 200). In this specific case, application 210-b may correspond to a time entry application, with a suggested matter 240, a timer 245, and/or a suggested entry 250. Any number of these fields may be populated with values determined by the machine-learned model based on the data context for the email application 210a, based on data records retrieved from a database, or based on a combination thereof. For example, a user may select action suggestion 235-b indicating “Create a Time Entry.” In one specific example, the plugin 255 may display application 210-b and may populate the suggested matter 240 field with information based on the subject line 225 of the displayed email in the email application 210-a. Furthermore, the plugin 255 may populate the suggested entry 250 with information based on words or phrases in the body 230 of the displayed email in the email application 210-a. This automatically populated information may be determined according to a machine-learned model, the data context, information queried from a database, or some combination of these. In some cases, the populated information may be user-specific to user device 205 or a user operating user device 205.

In some cases, the machine-learned model my produce a single suggestion. In other cases, the machine-learned model may produce multiple un-associated suggestions. In yet other cases, the model may produce a sequence of suggestions for application 210a, such as task suggestions 235-a and 235-b. In these cases, the task suggestions 235 may correspond to an ordered or non-ordered sequence of tasks for the user or user device 205 to execute.

In some cases, rather than suggest specific tasks, the model may launch a suggested application 210-b, which may contain suggestion-specific information, such as suggested matter 240, timer 245, suggested entry 250, or some combination of these or other suggestion-specific information. This application 210-b may be embedded within the first application 210-a (e.g., as a plugin 255).

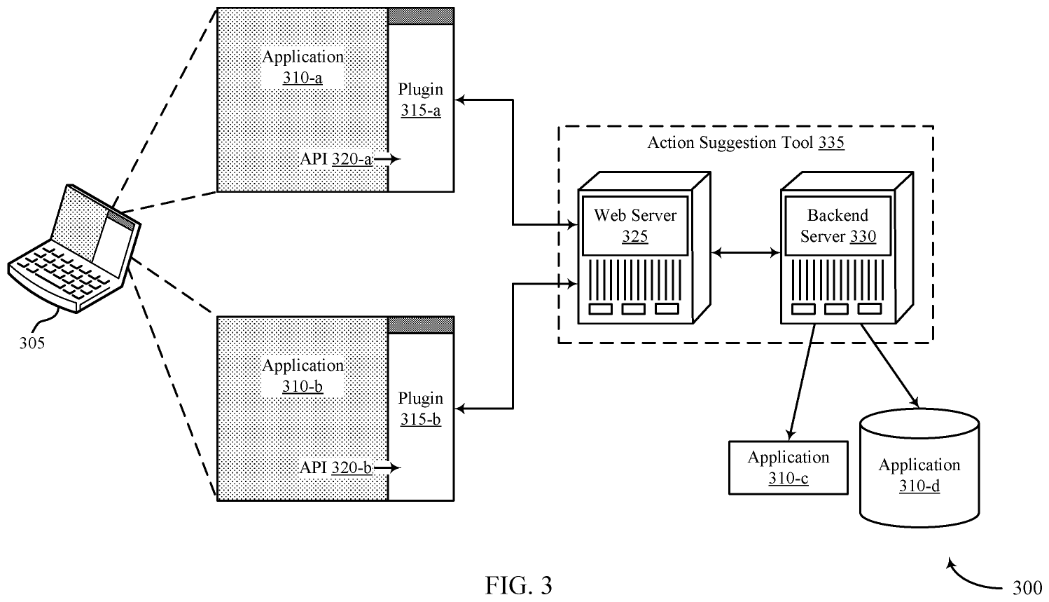

FIG. 3 illustrates an example of a system 300 that supports automatic action loading based on a data context and a machine-learned model in accordance with aspects of the present disclosure. The system 300 may be an example of a system 100 as described with reference to FIG. 1. The system 300 may include a user device 305 which may be an example of a user device 105 or 205 as described with reference to FIGS. 1 and 2. The system 300 may additionally include an action suggestion tool 335, which may run on the user device 305 or one or more servers, such as a web server 325, a backend server 330, or both. In some cases, model training for the action suggestion tool 335 may run on one or more servers, while the predictions performed by a trained model may run on the user device 305 or a server. The system 300 may support secure transfer of data between devices to provide model training and implementation. Furthermore, the system 300 may support plugins 315 for multiple applications 310, providing support for a variety of features and tasks.

The user device 305 may run a first application 310a, and a user operating the user device 305 may interact with the first application 310-a via the user interface of the user device 305. In addition to the first application 310a, the user device 305 may present a plugin 315-a for the first application 310-a. This plugin 315-a may run on the user device 305 or be hosted by a web server 325. The plugin 315-a may use data from the application 310-a to perform action suggestion (e.g., using an action suggestion tool 335). The plugin 315-a may read data from the application 310-a using an application programming interface (API) 320-a. For example, if the first application 310-a is Microsoft® Outlook, the plugin 315-a may access information in Microsoft® Outlook via a Microsoft® API. In some cases, the plugin 315-a may read data from the application 310-a corresponding to a data context input vector for a machine-learned model. In other cases, the plugin 315-a may read data from the application 310-a corresponding to historical context data for data storage, which may be a superset of the data used for the data context input vector. For example, the historical context data may include the data context input vector as well as additional information, such as a timestamp, a date, hypertext markup language (HTML) wrapping an email body, etc. In some cases, the API 320-a may write data to the application 310-a based on the plugin 315-a.

In some cases, if the action suggestion tool 335 is stored locally at the user device 305, the plugin 315-a may generate a data context vector based on the data retrieved from the application 310-a via the API 320-a and may input the data context vector into a machine-learned model. The model may output one or more suggested actions to perform, where these actions may correspond to other applications 310 (e.g., applications 310 different from application 310-a displayed at the user device 305). The user device 305 may present the suggested action(s) in the plugin 315-a, such that a user viewing the application 310-a running on the user device 305 may simultaneously view one or more actions to perform in other applications 310 within the plugin 315-a for the application 310-a. In some examples, these suggested actions may include information read from the application 310-a.

In other cases, the action suggestion tool 335 may run on the backend. For example, a web server 325 may host the plugin 315-a (e.g., as a JavaScript webpage). That is, the web server 325 may display the plugin 315-a as a side panel to the application 310-a in the user interface of the user device 305. Additionally, a backend server 330 may support the web server 325 by determining actions for the web server 325 to perform and/or components for the web server 325 to display. Alternatively, a single server may perform the processes described herein with respect to the web server 325 and the backend server 330. In some implementations, the action suggestion tool 335 may be hosted in the cloud, and one or more cloud servers may perform the processing described herein.

Using the server(s), the system 300 may allow the plugin 315-a for the first application 310-a to interact with other applications 310 and/or one or more databases. For example, information read from the first application 310-a by the plugin 315-a may be passed by the web server 325 to the backend server 330 and on to one or more databases for storage. For example, historical data may be stored in a database specific to the first application 310a, in a database supporting machine-learning, or in some other database or data storage system. This data may be retrieved for machine-learning purposes by the action suggestion tool 335. In some cases, if a user selects to perform an action suggested by the plugin 315-a, the action may involve information stored in the application 310-a. Information that originates in application 310-a may be processed by the plugin 315-a and one or more servers prior to interaction with another application 310. For example, if application 310-c is a time entry application, the plugin 315-a may retrieve a docket number from an email displayed in application 310-a and may display—in the side panel—a suggested time entry with the corresponding docket number. The user operating the user device 305 may edit the time entry directly in the plugin 315-a (e.g., without navigating away from the email application 310-a to the time entry application 310-c) and may select to submit the time entry. This user selection may trigger the plugin 315-a to send the time entry information to the time entry application 310-c for submission (e.g., via the web server 325 and the backend server 330 using an API and/or plugin for the time entry application 310-c). In this way, information in the first application 310-a may automatically be used in a different application 310 without manual entry by a user. In another example, the plugin 315-a may retrieve a document from the first application 310-a for filing in a document filing system application 310-d (e.g., via one or more backend processes or servers).

Additionally or alternatively, the action suggestion tool 335 may link data contexts for multiple applications 310 for improved action suggestions. For example, a user operating the user device 305 may open a second application 310-b, including a plugin 315-b for the second application 310-b. This second plugin 315-b may read information from this second application 310-b using an API 320-b. The second plugin 315-b may run the information through a machine-learned model (e.g., a model specific to the second application 310-b) to determine action suggestions to display in the second plugin 315-b. In some cases, plugin 315-a may perform machine-learning on data from application 310-a and plugin 315-b may perform machine-learning on data from application 310-b. However, in other cases, the machine-learning for a plugin 315 may be based on multiple applications 310. For example, application 310-a and application 310-b may be associated with one another (e.g., based on a same user identifier for the user running the applications 310 on the user device 305). Accordingly, a data context may be based on information in both of these applications 310. That is, plugin 315-b may suggest an action based on a data context in application 310a, application 310-b, or both applications 310-a and 310-b. In one specific example, if application 310-a is an email application and application 310-b is a word processing application, the plugin 315-b for the word processing application may display one or more suggested actions based on an email received, sent, or displayed in the email application. In such an implementation, both plugins 315-a and 315-b may be associated with a same backend (e.g., a same machine-learning training procedure).

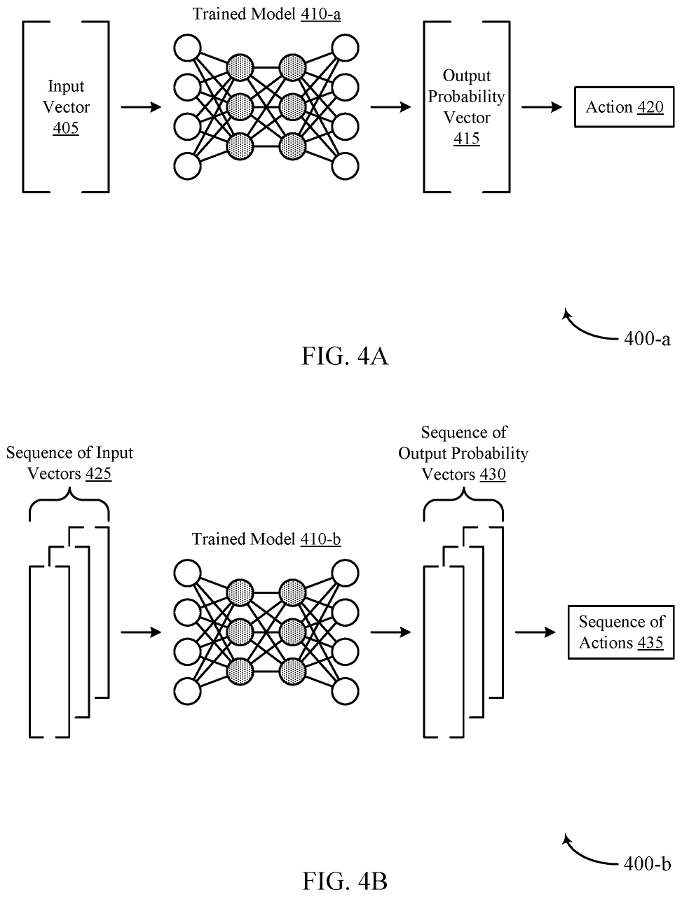

FIGS. 4A and 4B illustrate examples of machine-learned models 400 that support automatic action loading based on a data context and a machine-learned model in accordance with aspects of the present disclosure. FIG. 4A illustrates a machine-learned model 400-a based on a single input vector 405 and resulting in a single output probability vector 415. The trained model 410-a may be an example of an LSVM. In some cases, a system (e.g., a system 100 or 300 described herein with reference to FIGS. 1 and 3) may implement the machine-learned model 400-a.

The machine-learned model 400-a may receive a data context from one or more applications and may generate an input vector 405 based on the data context. This may involve setting values in the input vector 405 based on the data context, performing word-to-vector (word2vec) operations or other word embedding operations on input text, performing vector mapping into a vector space, or some combination of these processes to generate the input vector 405. In a specific example (e.g., if the data context is based on an email application), the input vector 405 may include a set of rows corresponding to features of an email. Each row of the input vector 405 may correspond to a respective feature. Example features for an email data context may include, but are not limited to, the number of recipients of an email, the types of recipients (e.g., recipients internal to an organization, external to an organization, with specific roles within an organization, etc.), the number of attachments to the email, the types of attachments, an integer, decimal, or vector value calculated using an NLP analysis of the email (e.g., based on the subject line of the email, the body of the email, or both), a client matter number, a docket number, and whether the email is sent to or sent by the user running the machine-learned model 400-a.

The resulting input vector 405 may be input into a trained model 410-a. For example, each input node of an input layer of the trained model 410-a may be set to a value for a respective feature of the input vector 405. These values may pass through the trained model 410-a and may be modified and combined according to the trained model 410-a. The resulting values (e.g., output in respective output nodes of an output layer) may form the rows of an output probability vector 415. Each row of this output probability vector 415 may correspond to a respective suggested action to perform, where a higher probability value indicates an action or application more likely to be performed or loaded. The machine-learned model 400-a may output one or more actions 420 (e.g., tasks to perform, applications to load, etc.) based on the output probability vector 415. In one example, the machine-learned model 400-a may output the action 420 corresponding to the highest probability value in the output probability vector 415. In another example, the machine-learned model 400-a may output a configured number of actions 420 with the highest probability values (e.g., ranked from highest to lowest probability), where the number may be configured statically or dynamically. Additionally or alternatively, the machine-learned model 400-a may output any actions 420 with a corresponding probability value greater than a threshold probability value, where the threshold may be static or dynamic. The determined action(s) 420 may be sent for presentation (e.g., display) in a user interface as suggested actions to perform. Based on the single input vector 405 and single output vector, the machine-learned model 400-a presents a single next action to perform.

The trained model 410-a may be a universal model or may be specific to a user or group of users. For example, the trained model 410-a may correspond to a certain application (e.g., Microsoft® Outlook), a certain organization (e.g., an organization licensing the use of the action suggestion tool, such as a law firm), a certain type or category of users (e.g., attorneys versus paralegals in a law firm), a specific user (e.g., associated with a specific user identifier, access token, biometric, etc.), or some combination of these. In some cases, the trained model 410-a may be updated to include different inputs and/or outputs. For example, the input vector 405 may be updated to remove a feature, add a feature, change a feature, or perform some combination of these. Additionally or alternatively, the output probability vector 415 may be updated to remove an action, add an action, change an action, or perform some combination of these. In any of these examples, the system may use transfer learning to update the trained model 410-a to handle the updated input(s) and/or output(s), or the system may perform full re-training of the model. Additionally or alternatively, the trained model 410-a may be updated (e.g., using transfer learning or complete model training) to handle a new application, a new user or group of users, a new granularity, or some combination of these.

FIG. 4B illustrates a machine-learned model 400-b based on a sequence of input vectors 425 and resulting in a sequence of output probability vectors 430. The trained model 410-b may be an example of a seq2seq model. In some cases, a system (e.g., a system 100 or 300 described herein with reference to FIGS. 1 and 3) may implement the machine-learned model 400-b or some combination of the machine-learned model 400-a and the machine-learned model 400-b.

The machine-learned model 400-b may receive a data context from one or more applications and may generate a sequence of input vectors 425 based on the data context. For example, the sequence of input vectors 425 may be based on a time sequence of data contexts and/or actions performed by a user. These input vectors may be similar to the input vector 405 described with reference to FIG. 4A. The trained model 410-b may process the sequence of input vectors 425 and output a sequence of output probability vectors 430. The sequence of output probability vectors 430 may correspond to an ordered or unordered sequence of actions 435 (e.g., an ensemble of actions) to perform. For example, if the sequence of output probability vectors 430 includes three vectors, the first vector may indicate a first suggested action for a user to perform, the second vector may indicate a second suggested action for the user to perform, and the third vector may indicate a third suggested action for the user to perform (e.g., to be performed in the specified order). This suggested sequence of actions 435 may be sent for presentation (e.g., display) in a user interface as suggested actions to perform, and in some cases may be ranked by probability or by a suggested order for performing the actions. Based on the sequence of input vectors 425 and sequence of output vectors, the machine-learned model 400-b presents a sequence of next actions to perform.

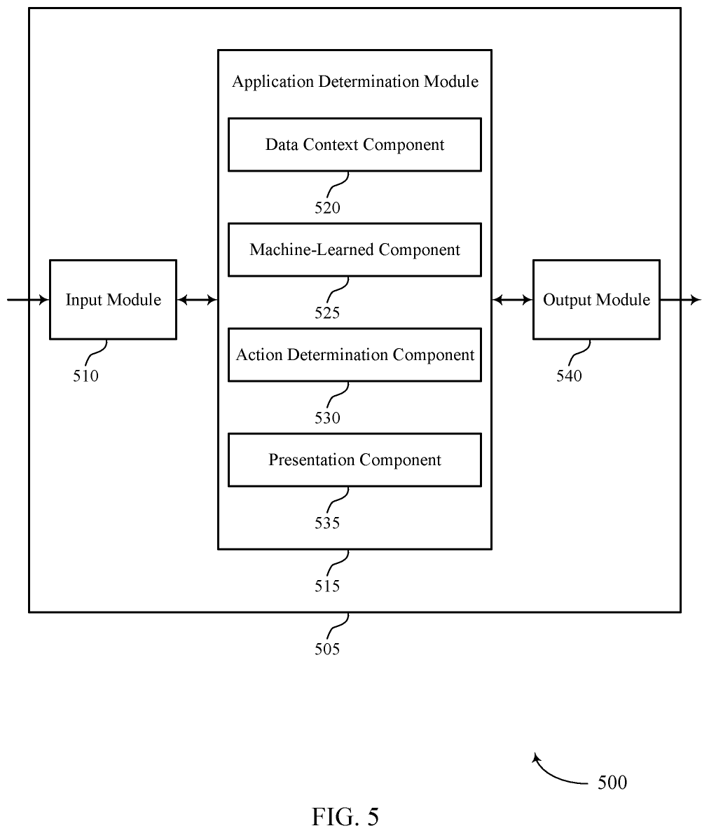

FIG. 5 shows a block diagram 500 of an apparatus 505 that supports automatic action loading based on a data context and a machine-learned model in accordance with aspects of the present disclosure. The apparatus 505 may include an input module 510, an application determination module 515, and an output module 540. The apparatus 505 may also include a processor. Each of these components may be in communication with one another (e.g., via one or more buses). In some cases, the apparatus 505 may be an example of a user device, a server (e.g., an application server, a cloud server, a database server, etc.), or a system containing multiple computing devices.

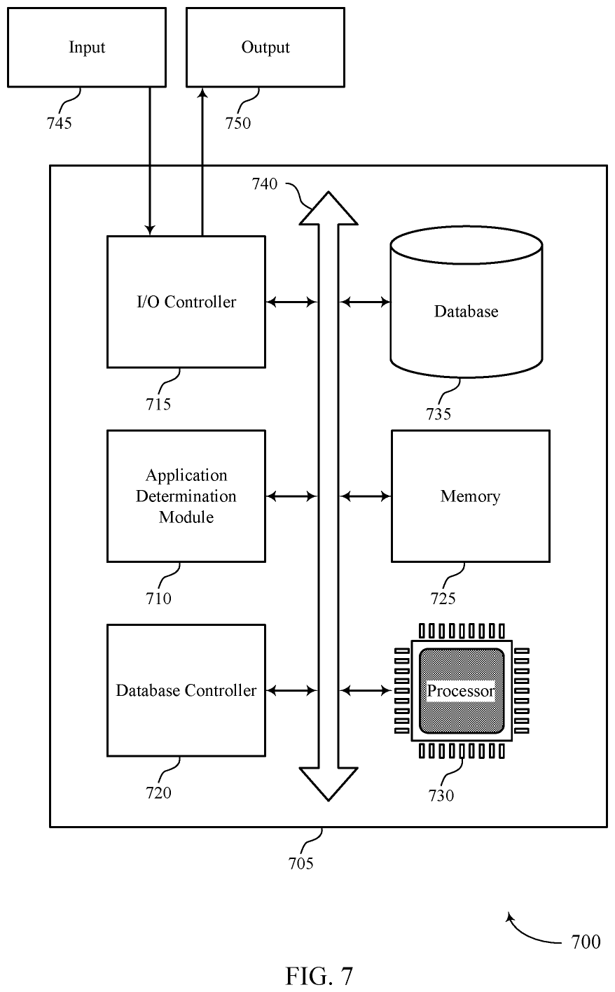

The input module 510 may manage input signals for the apparatus 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the apparatus 505 for processing. For example, the input module 510 may transmit input signals to the application determination module 515 to support automatic action selection based on a machine-learned model. In some cases, the input module 510 may be a component of an input/output (I/O) controller 715 as described with reference to FIG. 7.

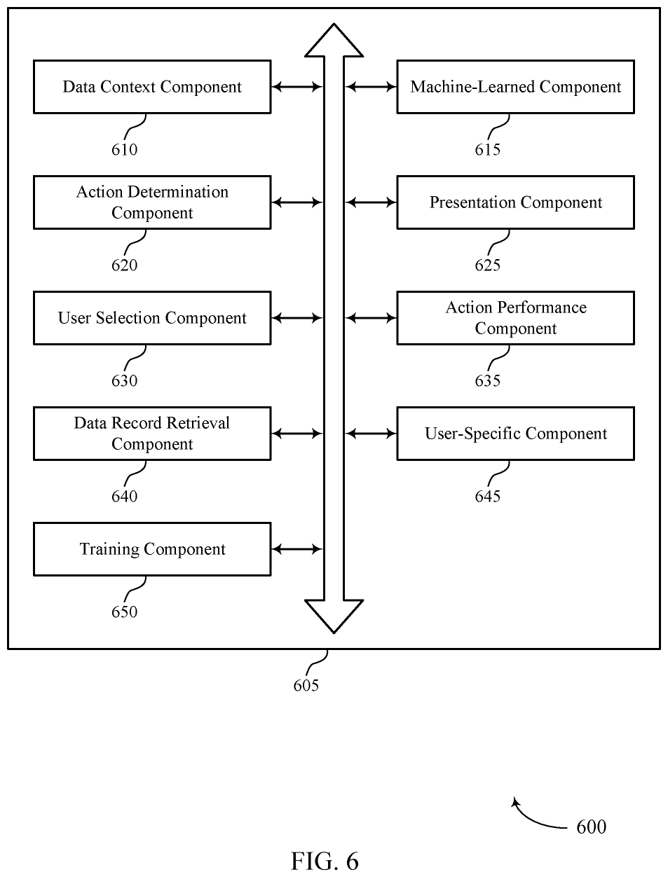

The application determination module 515 may include a data context component 520, a machine-learned component 525, an action determination component 530, and a presentation component 535. The application determination module 515 may be an example of aspects of the application determination module 605 or 710 described with reference to FIGS. 6 and 7.

The application determination module 515 and/or at least some of its various sub-components may be implemented in hardware, software executed by a processor, firmware, or any combination thereof. If implemented in software executed by a processor, the functions of the application determination module 515 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The application determination module 515 and/or at least some of its various sub-components may be physically located at various positions, including being distributed such that portions of functions are implemented at different physical locations by one or more physical devices. In some examples, the application determination module 515 and/or at least some of its various sub-components may be a separate and distinct component in accordance with various aspects of the present disclosure. In other examples, the application determination module 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The data context component 520 may obtain a data context associated with a first application presented in a user interface of a user device. The machine-learned component 525 may perform a machine-learned function using the data context associated with the first application. The action determination component 530 may determine a suggested action for a second application different from the first application based on performing the machine-learned function. The presentation component 535 may output, for presentation in the user interface of the user device, the suggested action for the second application.

The output module 540 may manage output signals for the apparatus 505. For example, the output module 540 may receive signals from other components of the apparatus 505, such as the application determination module 515, and may transmit these signals to other components or devices. In some specific examples, the output module 540 may transmit output signals for presentation (e.g., display) in a user interface, for storage in a database or data store, for further processing at a server or server cluster, or for any other processes at any number of devices or systems. In some cases, the output module 540 may be a component of an I/O controller 715 as described with reference to FIG. 7.

FIG. 6 shows a block diagram 600 of an application determination module 605 that supports automatic action loading based on a data context and a machine-learned model in accordance with aspects of the present disclosure. The application determination module 605 may be an example of aspects of an application determination module 515 or an application determination module 710 described herein. The application determination module 605 may include a data context component 610, a machine-learned component 615, an action determination component 620, a presentation component 625, a user selection component 630, an action performance component 635, a data record retrieval component 640, a user-specific component 645, and a training component 650. Each of these modules may communicate, directly or indirectly, with one another (e.g., via one or more buses).

The data context component 610 may obtain a data context associated with a first application presented (e.g., displayed) in a user interface of a user device. The machine-learned component 615 may perform a machine-learned function using the data context associated with the first application. In some examples, performing the machine-learned function may involve the machine-learned component 615 generating a vector based on the data context associated with the first application. The machine-learned component 615 may input the generated vector into the machine-learned function and may obtain, as output of the machine-learned function, a probability vector indicating a set of probability values, where each probability value of the set of probability values corresponds to a respective suggested action.

The action determination component 620 may determine a suggested action for a second application different from the first application based on performing the machine-learned function. In some cases, the determined suggested action for the second application corresponds to the greatest probability value of the set of probability values in an output probability vector. In some examples, the action determination component 620 may determine a set of suggested actions for one or more applications including at least the second application based on performing the machine-learned function.

The presentation component 625 may output, for presentation in the user interface of the user device, the suggested action for the second application. In some examples, the presentation component 625 may output, for presentation in the user interface of the user device, a set of suggested actions for one or more applications.

In some examples, the data context component 610 may obtain an additional data context associated with a third application presented (e.g., displayed) in the user interface of the user device. In some of these examples, the machine-learned component 615 may perform an additional machine-learned function using the data context associated with the first application and the additional data context associated with the third application, and the action determination component 620 may determine an additional suggested action for a fourth application different from the third application based on performing the additional machine-learned function. In some of these examples, the presentation component 625 may output, for presentation in the user interface of the user device, the additional suggested action for the fourth application.

The user selection component 630 may obtain an indication of a user selection of the suggested action for the second application in the user interface. The action performance component 635 may perform one or more functions associated with the second application based on the user selection. In some examples, performing the one or more functions associated with the second application may involve the action performance component 635 obtaining data from a plugin for the first application, where the suggested action for the second application is presented in the user interface of the user device within the plugin for the first application. In some of these examples, the action performance component 635 may output, to the second application, the data from the plugin for the first application. In some examples, the action performance component 635 may automatically perform a suggested action based on a configuration of the machine-learned function.

The data record retrieval component 640 may retrieve data records for the second application based on the data context and the suggested action for the second application. In some examples, the presentation component 625 may output, for presentation in the user interface of the user device, the retrieved data records for the second application. In some examples, the user selection component 630 may obtain an indication of a user selection of the suggested action for the second application in the user interface, where the data records for the second application are retrieved based on the user selection.

The user-specific component 645 may determine a user, a type of users, a group of users, or a combination thereof operating the first application based on a user identifier, where the machine-learned function is specific to the determined user, type of users, group of users, or combination thereof.

The training component 650 may receive, from a database for the first application, historical data context information for the first application and may train a machine learning model using the historical data context information for the first application, where the machine-learned function is based on the trained machine learning model. In some examples, training the machine learning model may further involve the training component 650 training the machine learning model using the data context associated with the first application, an indication of a user selection in the user interface, or both. In some examples, the training component 650 may determine an updated machine-learned function based on the training and a periodic trigger, a performance-based trigger, a user selection, or a combination thereof.

FIG. 7 shows a diagram of a system 700 including a device 705 that supports automatic action loading based on a data context and a machine-learned model in accordance with aspects of the present disclosure. The device 705 may be an example of or include the components of a server, a user device, or an apparatus 505 as described herein. The device 705 may include components for bi-directional data communications including components for transmitting and receiving communications, including an application determination module 710, an I/O controller 715, a database controller 720, memory 725, a processor 730, and a database 735. These components may be in electronic communication via one or more buses (e.g., bus 740).

The application determination module 710 may be an example of an application determination module 515 or 605 as described herein. For example, the application determination module 710 may perform any of the methods or processes described above with reference to FIGS. 5 and 6. In some cases, the application determination module 710 may be implemented in hardware, software executed by a processor, firmware, or any combination thereof.

The I/O controller 715 may manage input signals 745 and output signals 750 for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The database controller 720 may manage data storage and processing in a database 735. In some cases, a user may interact with the database controller 720. In other cases, the database controller 720 may operate automatically without user interaction. The database 735 may be an example of a single database, a distributed database, multiple distributed databases, a data store, cloud-based storage, local storage, or an emergency backup database.

Memory 725 may include random-access memory (RAM) and read-only memory (ROM). The memory 725 may store computer-readable, computer-executable software including instructions that, when executed, cause the processor to perform various functions described herein. In some cases, the memory 725 may contain, among other things, a basic I/O system (BIOS) which may control basic hardware or software operation such as the interaction with peripheral components or devices.

The processor 730 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting automatic action loading based on a data context and a machine-learned model).

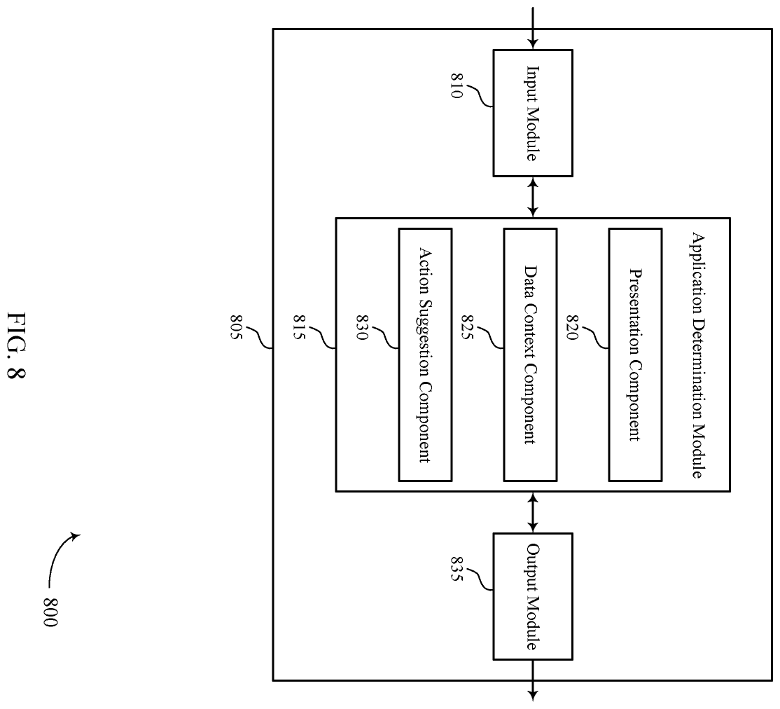

FIG. 8 shows a block diagram 800 of an apparatus 805 that supports automatic action loading based on a data context and a machine-learned model in accordance with aspects of the present disclosure. The apparatus 805 may include an input module 810, an application determination module 815, and an output module 835. The apparatus 805 may also include a processor. Each of these components may be in communication with one another (e.g., via one or more buses). In some cases, the apparatus 805 may be an example of a user device, a server, or a system containing multiple computing devices.

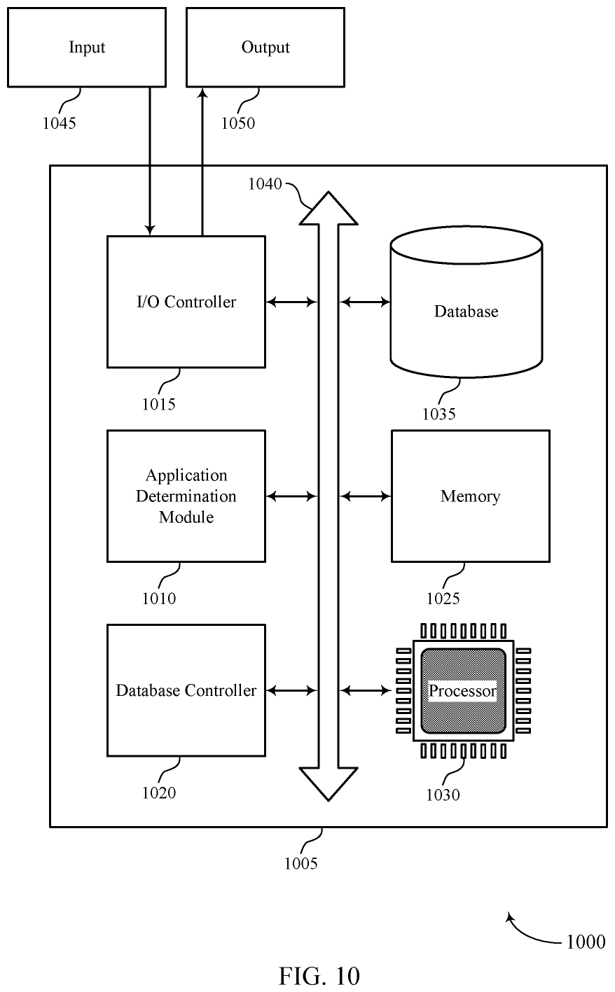

The input module 810 may manage input signals for the apparatus 805. For example, the input module 810 may identify input signals based on an interaction with a modem, a keyboard, a mouse, a touchscreen, or a similar device. These input signals may be associated with user input or processing at other components or devices. In some cases, the input module 810 may utilize an operating system such as iOS®, ANDROID®, MS-DOS®, MS-WINDOWS®, OS/2®, UNIX®, LINUX®, or another known operating system to handle input signals. The input module 810 may send aspects of these input signals to other components of the apparatus 805 for processing. For example, the input module 810 may transmit input signals to the application determination module 815 to support automatic action loading based on a data context and a machine-learned model. In some cases, the input module 810 may be a component of an I/O controller 1015 as described with reference to FIG. 10.

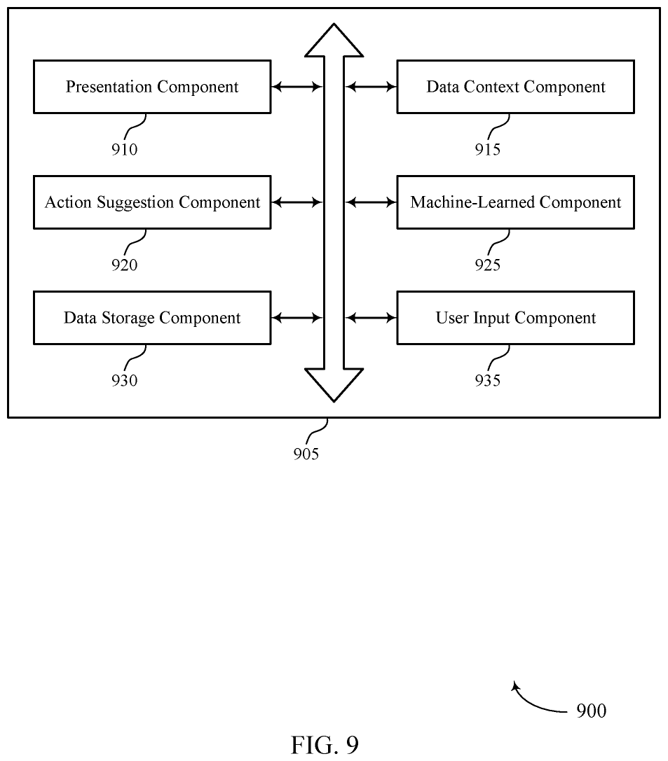

The application determination module 815 may include a presentation component 820, a data context component 825, and an action suggestion component 830. The application determination module 815 may be an example of aspects of the application determination module 905 or 1010 described with reference to FIGS. 9 and 10.

The application determination module 815 and/or at least some of its various sub-components may be implemented in hardware, software executed by a processor, firmware, or any combination thereof. If implemented in software executed by a processor, the functions of the application determination module 815 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The application determination module 815 and/or at least some of its various sub-components may be physically located at various positions, including being distributed such that portions of functions are implemented at different physical locations by one or more physical devices. In some examples, the application determination module 815 and/or at least some of its various sub-components may be a separate and distinct component in accordance with various aspects of the present disclosure. In other examples, the application determination module 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The apparatus 805 may be a component of a user device. The presentation component 820 may present, in a user interface of the user device, a first application and a plugin for the first application. The data context component 825 may identify a data context associated with the first application presented in the user interface. The action suggestion component 830 may obtain a suggested action for a second application different from the first application based on the data context associated with the first application and a machine-learned function. The presentation component 820 may present, in the user interface of the user device, the suggested action for the second application within the plugin for the first application.

The output module 835 may manage output signals for the apparatus 805. For example, the output module 835 may receive signals from other components of the apparatus 805, such as the application determination module 815, and may transmit these signals to other components or devices. In some specific examples, the output module 835 may transmit output signals for presentation (e.g., display) in a user interface, for storage in a database or data store, for further processing at a server or server cluster, or for any other processes at any number of devices or systems. In some cases, the output module 835 may be a component of an I/O controller 1015 as described with reference to FIG. 10.

FIG. 9 shows a block diagram 900 of an application determination module 905 that supports automatic action loading based on a data context and a machine-learned model in accordance with aspects of the present disclosure. The application determination module 905 may be an example of aspects of an application determination module 815 or an application determination module 1010 described herein. The application determination module 905 may include a presentation component 910, a data context component 915, an action suggestion component 920, a machine-learned component 925, a data storage component 930, and a user input component 935. Each of these modules may communicate, directly or indirectly, with one another (e.g., via one or more buses). In some cases, the application determination module 905 may be a component of a user device.

The presentation component 910 may present (e.g., display), in a user interface of the user device, a first application and a plugin for the first application. The data context component 915 may identify a data context associated with the first application presented in the user interface. The action suggestion component 920 may obtain a suggested action for a second application different from the first application based on the data context associated with the first application and a machine-learned function. The presentation component 910 may present (e.g., display), in the user interface of the user device, the suggested action for the second application within the plugin for the first application.

In some examples, the data context component 915 may transmit, to a server hosting the plugin for the first application, the data context associated with the first application, where the suggested action is obtained from the server via an API.

In other examples, the machine-learned component 925 may perform the machine-learned function using the data context associated with the first application, where the suggested action is obtained as an output of the machine-learned function. In some cases, the machine-learned component 925 may receive, from a server hosting a machine learning environment, the machine-learned function based on downloading the plugin for the first application.

The data storage component 930 may transmit, to a database storing historical data for the first application, the data context associated with the first application.

The user input component 935 may receive, at the user interface, a user input signal corresponding to the suggested action for the second application. In some examples, the user input component 935 may output an indication of the user input signal based on receiving the user input signal.

FIG. 10 shows a diagram of a system 1000 including a device 1005 that supports automatic action loading based on a data context and a machine-learned model in accordance with aspects of the present disclosure. The device 1005 may be an example of or include the components of a user device or an apparatus 805 as described herein. The device 1005 may include components for bi-directional data communications including components for transmitting and receiving communications, including an application determination module 1010, an I/O controller 1015, a database controller 1020, memory 1025, a processor 1030, and a database 1035. These components may be in electronic communication via one or more buses (e.g., bus 1040).

The application determination module 1010 may be an example of an application determination module 815 or 905 as described herein. For example, the application determination module 1010 may perform any of the methods or processes described above with reference to FIGS. 8 and 9. In some cases, the application determination module 1010 may be implemented in hardware, software executed by a processor, firmware, or any combination thereof.

The I/O controller 1015 may manage input signals 1045 and output signals 1050 for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The database controller 1020 may manage data storage and processing in a database 1035. In some cases, a user may interact with the database controller 1020. In other cases, the database controller 1020 may operate automatically without user interaction. The database 1035 may be an example of a single database, a distributed database, multiple distributed databases, a data store, cloud-based storage, local storage, or an emergency backup database.

Memory 1025 may include RAM and ROM. The memory 1025 may store computer-readable, computer-executable software including instructions that, when executed, cause the processor to perform various functions described herein. In some cases, the memory 1025 may contain, among other things, a BIOS which may control basic hardware or software operation such as the interaction with peripheral components or devices.

The processor 1030 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1030 may be configured to operate a memory array using a memory controller. In other cases, a memory controller may be integrated into the processor 1030. The processor 1030 may be configured to execute computer-readable instructions stored in a memory 1025 to perform various functions (e.g., functions or tasks supporting automatic action loading based on a data context and a machine-learned model).

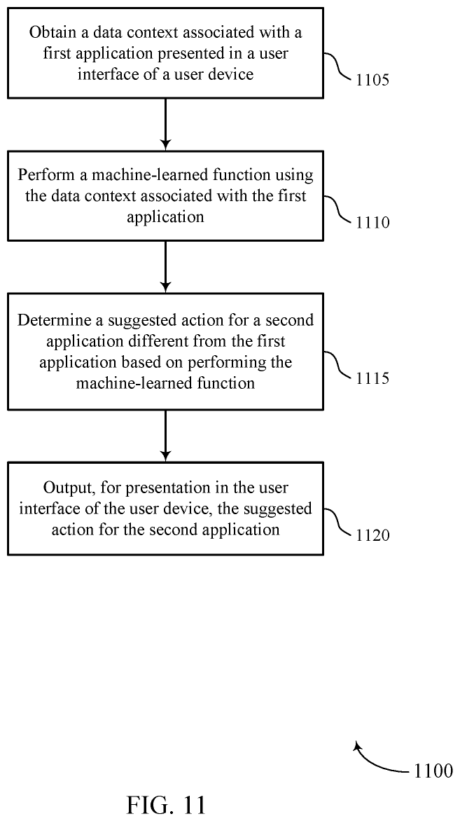

FIG. 11 shows a flowchart illustrating a method 1100 that supports automatic action loading based on a data context and a machine-learned model in accordance with aspects of the present disclosure. The operations of method 1100 may be implemented by a server (e.g., an application server, a cloud server, a database server, etc.), a user device, or components of a server or user device as described herein. For example, the operations of method 1100 may be performed by an application determination module as described with reference to FIGS. 5 through 7. In some examples, a server or user device may execute a set of instructions to control the functional elements of the server or user device to perform the functions described below. Additionally or alternatively, a server or user device may perform aspects of the functions described below using special-purpose hardware.

At 1105, the server or user device may obtain a data context associated with a first application presented in a user interface of a user device. The operations of 1105 may be performed according to the methods described herein. In some examples, aspects of the operations of 1105 may be performed by a data context component as described with reference to FIGS. 5 through 7.

At 1110, the server or user device may perform a machine-learned function using the data context associated with the first application. The operations of 1110 may be performed according to the methods described herein. In some examples, aspects of the operations of 1110 may be performed by a machine-learned component as described with reference to FIGS. 5 through 7.

At 1115, the server or user device may determine a suggested action for a second application different from the first application based on performing the machine-learned function. The operations of 1115 may be performed according to the methods described herein. In some examples, aspects of the operations of 1115 may be performed by an action determination component as described with reference to FIGS. 5 through 7.

At 1120, the server or user device may output, for presentation in the user interface of the user device, the suggested action for the second application. The operations of 1120 may be performed according to the methods described herein. In some examples, aspects of the operations of 1120 may be performed by a presentation component as described with reference to FIGS. 5 through 7.

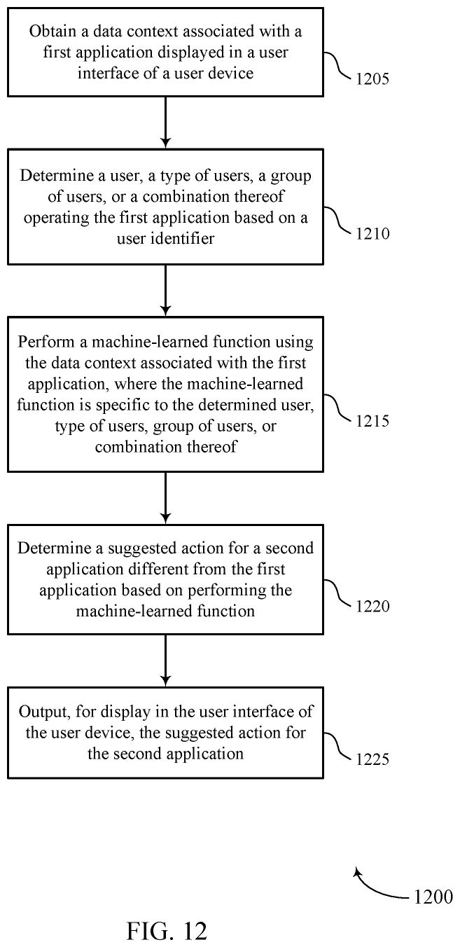

FIG. 12 shows a flowchart illustrating a method 1200 that supports automatic action loading based on a data context and a machine-learned model in accordance with aspects of the present disclosure. The operations of method 1200 may be implemented by a server (e.g., an application server, a cloud server, a database server, etc.), a user device, or components of a server or user device as described herein. For example, the operations of method 1200 may be performed by an application determination module as described with reference to FIGS. 5 through 7. In some examples, a server or user device may execute a set of instructions to control the functional elements of the server or user device to perform the functions described below. Additionally or alternatively, a server or user device may perform aspects of the functions described below using special-purpose hardware.

At 1205, the server or user device may obtain a data context associated with a first application displayed in a user interface of a user device. The operations of 1205 may be performed according to the methods described herein. In some examples, aspects of the operations of 1205 may be performed by a data context component as described with reference to FIGS. 5 through 7.

At 1210, the server or user device may determine a user, a type of users, a group of users, or a combination thereof operating the first application based on a user identifier, where a machine-learned function is specific to the determined user, type of users, group of users, or combination thereof. The operations of 1210 may be performed according to the methods described herein. In some examples, aspects of the operations of 1210 may be performed by a user-specific component as described with reference to FIGS. 5 through 7.

At 1215, the server or user device may perform the machine-learned function using the data context associated with the first application. The operations of 1215 may be performed according to the methods described herein. In some examples, aspects of the operations of 1215 may be performed by a machine-learned component as described with reference to FIGS. 5 through 7.

At 1220, the server or user device may determine a suggested action for a second application different from the first application based on performing the machine-learned function. The operations of 1220 may be performed according to the methods described herein. In some examples, aspects of the operations of 1220 may be performed by an action determination component as described with reference to FIGS. 5 through 7.

At 1225, the server or user device may output, for display in the user interface of the user device, the suggested action for the second application. The operations of 1225 may be performed according to the methods described herein. In some examples, aspects of the operations of 1225 may be performed by a display component as described with reference to FIGS. 5 through 7.

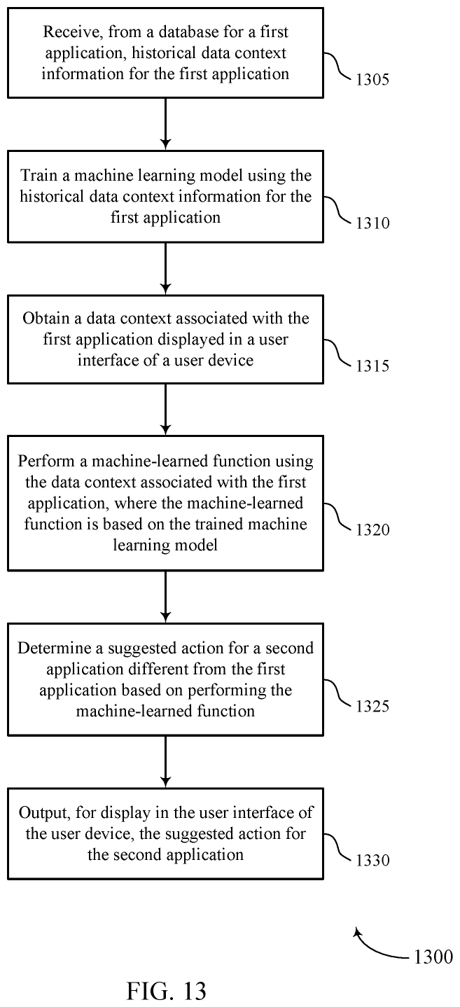

FIG. 13 shows a flowchart illustrating a method 1300 that supports automatic action loading based on a data context and a machine-learned model in accordance with aspects of the present disclosure. The operations of method 1300 may be implemented by a server (e.g., an application server, a cloud server, a database server, etc.), a user device, or components of a server or user device as described herein. For example, the operations of method 1300 may be performed by an application determination module as described with reference to FIGS. 5 through 7. In some examples, a server or user device may execute a set of instructions to control the functional elements of the server or user device to perform the functions described below. Additionally or alternatively, a server or user device may perform aspects of the functions described below using special-purpose hardware.

At 1305, the server or user device may receive, from a database for a first application, historical data context information for the first application. The operations of 1305 may be performed according to the methods described herein. In some examples, aspects of the operations of 1305 may be performed by a training component as described with reference to FIGS. 5 through 7.

At 1310, the server or user device may train a machine learning model using the historical data context information for the first application, where a machine-learned function is based on the trained machine learning model. The operations of 1310 may be performed according to the methods described herein. In some examples, aspects of the operations of 1310 may be performed by a training component as described with reference to FIGS. 5 through 7.

At 1315, the server or user device may obtain a data context associated with the first application displayed in a user interface of a user device. The operations of 1315 may be performed according to the methods described herein. In some examples, aspects of the operations of 1315 may be performed by a data context component as described with reference to FIGS. 5 through 7.

At 1320, the server or user device may perform the machine-learned function using the data context associated with the first application. The operations of 1320 may be performed according to the methods described herein. In some examples, aspects of the operations of 1320 may be performed by a machine-learned component as described with reference to FIGS. 5 through 7.

At 1325, the server or user device may determine a suggested action for a second application different from the first application based on performing the machine-learned function. The operations of 1325 may be performed according to the methods described herein. In some examples, aspects of the operations of 1325 may be performed by an action determination component as described with reference to FIGS. 5 through 7.

At 1330, the server or user device may output, for display in the user interface of the user device, the suggested action for the second application. The operations of 1330 may be performed according to the methods described herein. In some examples, aspects of the operations of 1330 may be performed by a display component as described with reference to FIGS. 5 through 7.

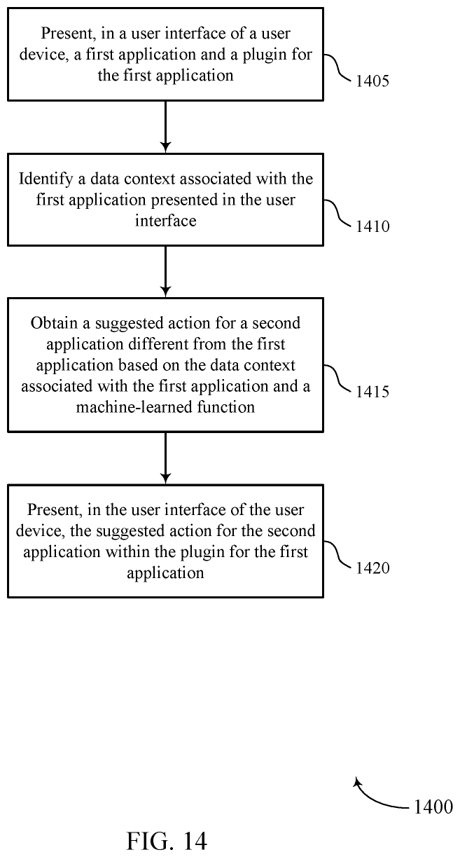

FIG. 14 shows a flowchart illustrating a method 1400 that supports automatic action loading based on a data context and a machine-learned model in accordance with aspects of the present disclosure. The operations of method 1400 may be implemented by a user device or its components as described herein. For example, the operations of method 1400 may be performed by an application determination module as described with reference to FIGS. 8 through 10. In some examples, a user device may execute a set of instructions to control the functional elements of the user device to perform the functions described below. Additionally or alternatively, a user device may perform aspects of the functions described below using special-purpose hardware.

At 1405, the user device may present (e.g., display), in a user interface of the user device, a first application and a plugin for the first application. The operations of 1405 may be performed according to the methods described herein. In some examples, aspects of the operations of 1405 may be performed by a presentation component as described with reference to FIGS. 8 through 10.

At 1410, the user device may identify a data context associated with the first application presented in the user interface. The operations of 1410 may be performed according to the methods described herein. In some examples, aspects of the operations of 1410 may be performed by a data context component as described with reference to FIGS. 8 through 10.

At 1415, the user device may obtain a suggested action for a second application different from the first application based on the data context associated with the first application and a machine-learned function. The operations of 1415 may be performed according to the methods described herein. In some examples, aspects of the operations of 1415 may be performed by an action suggestion component as described with reference to FIGS. 8 through 10.

At 1420, the user device may present (e.g., display), in the user interface of the user device, the suggested action for the second application within the plugin for the first application. The operations of 1420 may be performed according to the methods described herein. In some examples, aspects of the operations of 1420 may be performed by a presentation component as described with reference to FIGS. 8 through 10.

A method for automated action selection is described. The method may include obtaining a data context associated with a first application presented in a user interface of a user device, performing a machine-learned function using the data context associated with the first application, determining a suggested action for a second application different from the first application based on performing the machine-learned function, and outputting, for presentation in the user interface of the user device, the suggested action for the second application.

An apparatus for automated action selection is described. The apparatus may include a processor, memory coupled with the processor, and instructions stored in the memory. The instructions may be executable by the processor to cause the apparatus to obtain a data context associated with a first application presented in a user interface of a user device, perform a machine-learned function using the data context associated with the first application, determine a suggested action for a second application different from the first application based on performing the machine-learned function, and output, for presentation in the user interface of the user device, the suggested action for the second application.

Another apparatus for automated action selection is described. The apparatus may include means for obtaining a data context associated with a first application presented in a user interface of a user device, performing a machine-learned function using the data context associated with the first application, determining a suggested action for a second application different from the first application based on performing the machine-learned function, and outputting, for presentation in the user interface of the user device, the suggested action for the second application.

A non-transitory computer-readable medium storing code for automated action selection is described. The code may include instructions executable by a processor to obtain a data context associated with a first application presented in a user interface of a user device, perform a machine-learned function using the data context associated with the first application, determine a suggested action for a second application different from the first application based on performing the machine-learned function, and output, for presentation in the user interface of the user device, the suggested action for the second application.

Some examples of the method, apparatuses, and non-transitory computer-readable medium described herein may further include operations, features, means, or instructions for obtaining an indication of a user selection of the suggested action for the second application in the user interface and performing one or more functions associated with the second application based on the user selection. In some examples of the method, apparatuses, and non-transitory computer-readable medium described herein, performing the one or more functions associated with the second application may include operations, features, means, or instructions for obtaining data from a plugin for the first application, where the suggested action for the second application may be presented in the user interface of the user device within the plugin for the first application, and outputting, to the second application, the data from the plugin for the first application.

Some examples of the method, apparatuses, and non-transitory computer-readable medium described herein may further include operations, features, means, or instructions for retrieving data records for the second application based on the data context and the suggested action for the second application and outputting, for presentation in the user interface of the user device, the retrieved data records for the second application. Some examples of the method, apparatuses, and non-transitory computer-readable medium described herein may further include operations, features, means, or instructions for obtaining an indication of a user selection of the suggested action for the second application in the user interface, where the data records for the second application may be retrieved based on the user selection.

Some examples of the method, apparatuses, and non-transitory computer-readable medium described herein may further include operations, features, means, or instructions for determining a user, a type of users, a group of users, or a combination thereof operating the first application based on a user identifier, where the machine-learned function may be specific to the determined user, type of users, group of users, or combination thereof.

In some examples of the method, apparatuses, and non-transitory computer-readable medium described herein, determining the suggested action for the second application may include operations, features, means, or instructions for determining a set of suggested actions for one or more applications including at least the second application based on performing the machine-learned function, and outputting the suggested action for the second application may include operations, features, means, or instructions for outputting, for presentation in the user interface of the user device, the set of suggested actions for the one or more applications.

Some examples of the method, apparatuses, and non-transitory computer-readable medium described herein may further include operations, features, means, or instructions for obtaining an additional data context associated with a third application presented in the user interface of the user device, performing an additional machine-learned function using the data context associated with the first application and the additional data context associated with the third application, determining an additional suggested action for a fourth application different from the third application based on performing the additional machine-learned function, and outputting, for presentation in the user interface of the user device, the additional suggested action for the fourth application.

Some examples of the method, apparatuses, and non-transitory computer-readable medium described herein may further include operations, features, means, or instructions for receiving, from a database for the first application, historical data context information for the first application and training a machine learning model using the historical data context information for the first application, where the machine-learned function may be based on the trained machine learning model. In some examples of the method, apparatuses, and non-transitory computer-readable medium described herein, training the machine learning model further may include operations, features, means, or instructions for training the machine learning model using the data context associated with the first application, an indication of a user selection in the user interface, or both. Some examples of the method, apparatuses, and non-transitory computer-readable medium described herein may further include operations, features, means, or instructions for determining an updated machine-learned function based on the training and a periodic trigger, a performance-based trigger, a user selection, or a combination thereof.

In some examples of the method, apparatuses, and non-transitory computer-readable medium described herein, performing the machine-learned function may include operations, features, means, or instructions for generating a vector based on the data context associated with the first application, inputting the generated vector into the machine-learned function, and obtaining, as output of the machine-learned function, a probability vector indicating a set of probability values, where each probability value of the set of probability values corresponds to a respective suggested action, and where the determined suggested action for the second application corresponds to the greatest probability value of the set of probability values.

Some examples of the method, apparatuses, and non-transitory computer-readable medium described herein may further include operations, features, means, or instructions for determining an additional suggested action for a third application different from the first application based on performing the machine-learned function and automatically performing the additional suggested action based on a configuration of the machine-learned function.

A method for automated action selection at a user device is described. The method may include presenting, in a user interface of the user device, a first application and a plugin for the first application, identifying a data context associated with the first application presented in the user interface, obtaining a suggested action for a second application different from the first application based on the data context associated with the first application and a machine-learned function, and presenting, in the user interface of the user device, the suggested action for the second application within the plugin for the first application.

An apparatus for automated action selection at a user device is described. The apparatus may include a processor, memory coupled with the processor, and instructions stored in the memory. The instructions may be executable by the processor to cause the apparatus to present, in a user interface of the user device, a first application and a plugin for the first application, identify a data context associated with the first application presented in the user interface, obtain a suggested action for a second application different from the first application based on the data context associated with the first application and a machine-learned function, and present, in the user interface of the user device, the suggested action for the second application within the plugin for the first application.

Another apparatus for automated action selection at a user device is described. The apparatus may include means for presenting, in a user interface of the user device, a first application and a plugin for the first application, identifying a data context associated with the first application presented in the user interface, obtaining a suggested action for a second application different from the first application based on the data context associated with the first application and a machine-learned function, and presenting, in the user interface of the user device, the suggested action for the second application within the plugin for the first application.

A non-transitory computer-readable medium storing code for automated action selection at a user device is described. The code may include instructions executable by a processor to present, in a user interface of the user device, a first application and a plugin for the first application, identify a data context associated with the first application presented in the user interface, obtain a suggested action for a second application different from the first application based on the data context associated with the first application and a machine-learned function, and present, in the user interface of the user device, the suggested action for the second application within the plugin for the first application.

Some examples of the method, apparatuses, and non-transitory computer-readable medium described herein may further include operations, features, means, or instructions for transmitting, to a server hosting the plugin for the first application, the data context associated with the first application, where the suggested action may be obtained from the server via an API.

Some examples of the method, apparatuses, and non-transitory computer-readable medium described herein may further include operations, features, means, or instructions for performing the machine-learned function using the data context associated with the first application, where the suggested action may be obtained as an output of the machine-learned function. Some examples of the method, apparatuses, and non-transitory computer-readable medium described herein may further include operations, features, means, or instructions for receiving, from a server hosting a machine learning environment, the machine-learned function based on downloading the plugin for the first application.

Some examples of the method, apparatuses, and non-transitory computer-readable medium described herein may further include operations, features, means, or instructions for transmitting, to a database storing historical data for the first application, the data context associated with the first application.

Some examples of the method, apparatuses, and non-transitory computer-readable medium described herein may further include operations, features, means, or instructions for receiving, at the user interface, a user input signal corresponding to the suggested action for the second application and outputting an indication of the user input signal based on receiving the user input signal.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for automated action selection, comprising:
obtaining a data context associated with a first application presented in a user interface of a user device;
performing a machine-learned function using the data context associated with the first application;
determining a suggested action for a second application different from the first application based at least in part on performing the machine-learned function; and
outputting, for presentation in the user interface of the user device, the suggested action for the second application.

2. The method of claim 1, further comprising:
obtaining an indication of a user selection of the suggested action for the second application in the user interface; and
performing one or more functions associated with the second application based at least in part on the user selection.

3. The method of claim 2, wherein performing the one or more functions associated with the second application comprises:
obtaining data from a plugin for the first application, wherein the suggested action for the second application is presented in the user interface of the user device within the plugin for the first application; and
outputting, to the second application, the data from the plugin for the first application.

4. The method of claim 1, further comprising:
retrieving data records for the second application based at least in part on the data context and the suggested action for the second application; and
outputting, for presentation in the user interface of the user device, the retrieved data records for the second application.

5. The method of claim 4, further comprising:
obtaining an indication of a user selection of the suggested action for the second application in the user interface, wherein the data records for the second application are retrieved based at least in part on the user selection.

6. The method of claim 1, further comprising:
determining a user, a type of users, a group of users, or a combination thereof operating the first application based at least in part on a user identifier, wherein the machine-learned function is specific to the determined user, type of users, group of users, or combination thereof.

7. The method of claim 1, wherein:
determining the suggested action for the second application comprises:
determining a plurality of suggested actions for one or more applications comprising at least the second application based at least in part on performing the machine-learned function; and
outputting the suggested action for the second application comprises:
outputting, for presentation in the user interface of the user device, the plurality of suggested actions for the one or more applications.

8. The method of claim 1, further comprising:
obtaining an additional data context associated with a third application presented in the user interface of the user device;
performing an additional machine-learned function using the data context associated with the first application and the additional data context associated with the third application;
determining an additional suggested action for a fourth application different from the third application based at least in part on performing the additional machine-learned function; and
outputting, for presentation in the user interface of the user device, the additional suggested action for the fourth application.

9. The method of claim 1, further comprising:
receiving, from a database for the first application, historical data context information for the first application; and
training a machine learning model using the historical data context information for the first application, wherein the machine-learned function is based at least in part on the trained machine learning model.

10. The method of claim 9, wherein training the machine learning model further comprises:
training the machine learning model using the data context associated with the first application, an indication of a user selection in the user interface, or both.

11. The method of claim 9, further comprising:
determining an updated machine-learned function based at least in part on the training and a periodic trigger, a performance-based trigger, a user selection, or a combination thereof.

12. The method of claim 1, wherein performing the machine-learned function comprises:
generating a vector based at least in part on the data context associated with the first application;
inputting the generated vector into the machine-learned function; and
obtaining, as output of the machine-learned function, a probability vector indicating a plurality of probability values, wherein each probability value of the plurality of probability values corresponds to a respective suggested action, and wherein the determined suggested action for the second application corresponds to the greatest probability value of the plurality of probability values.

13. The method of claim 1, further comprising:
determining an additional suggested action for a third application different from the first application based at least in part on performing the machine-learned function; and
automatically performing the additional suggested action based at least in part on a configuration of the machine-learned function.

14. A method for automated action selection at a user device, comprising:
presenting, in a user interface of the user device, a first application and a plugin for the first application;
identifying a data context associated with the first application presented in the user interface;
obtaining a suggested action for a second application different from the first application based at least in part on the data context associated with the first application and a machine-learned function; and
presenting, in the user interface of the user device, the suggested action for the second application within the plugin for the first application.

15. The method of claim 14, further comprising:
transmitting, to a server hosting the plugin for the first application, the data context associated with the first application, wherein the suggested action is obtained from the server via an application programming interface.

16. The method of claim 14, further comprising:
performing the machine-learned function using the data context associated with the first application, wherein the suggested action is obtained as an output of the machine-learned function.

17. The method of claim 16, further comprising:
receiving, from a server hosting a machine learning environment, the machine-learned function based at least in part on downloading the plugin for the first application.

18. The method of claim 14, further comprising:
transmitting, to a database storing historical data for the first application, the data context associated with the first application.

19. The method of claim 14, further comprising:
receiving, at the user interface, a user input signal corresponding to the suggested action for the second application; and
outputting an indication of the user input signal based at least in part on receiving the user input signal.

20. An apparatus for automated action selection, comprising:
a processor;
memory coupled with the processor; and
instructions stored in the memory and executable by the processor to cause the apparatus to:
obtain a data context associated with a first application presented in a user interface of a user device;
perform a machine-learned function using the data context associated with the first application;
determine a suggested action for a second application different from the first application based at least in part on performing the machine-learned function; and
output, for presentation in the user interface of the user device, the suggested action for the second application.
